(19) United States
(12) Patent Application Publication
(10) Pub. No.: US 2006/0045695 A1
(43) Pub. Date: Mar. 2, 2006

(54) Ergonomic bay unloading product stacker (or TEBUPS)

(76) Inventor: Ronnie M. Long SR., Ringgold, GA (US)

Correspondence Address: Ronnie M. Long Sr., 538 Misty Ridge Lane, Ringgold, GA, 30736, US

(21) Appl. No.: 10/820,938

(22) Filed: Aug. 17, 2004

(51) Int. Cl. B62B 1/00

(52) U.S. Cl. 414/490

(57) ABSTRACT

The Ergonomic Bay Unloading Product Stacker (TEBUPS) is a device to aid in unloading bay-type delivery trucks used in the beverage industry and consists of a collapsible stand and sliding portion which are carried on the truck and removed and set-up at each delivery location where applicable. The delivery person places the stand next to the bay area of the truck and attaches the sliding portion to this stand. The delivery person then climbs onto the side of the truck, using the stand as a foothold and takes product from the truck bay area and places them onto the sliding portion of the TEBUPS. Each product case slides down the sliding portion ramp to a set of handtrucks that is held in position by backstops attached to the base of the sliding portion. After use, the sliding portion is detached from the stand, the delivery person collapses the stand and both stand and sliding portion are placed back onto the truck.

### CROSS REFERENCE TO RELATED APPLICATIONS

“Not Applicable”

### BACKGROUND OF THE INVENTION

This device will be used to establish an ergonomic tool for the beverage industry. It will greatly aid delivery drivers in unloading product from truck bays, especially when stacked high in bays. It will also help eliminate many costly back and upper torso injuries.

I conceived this while at home on Apr. 5, 1998 when considering the problems and resulting injuries that delivery truck drivers encounter. This tool/idea is believed to be entirely new.

There is no relevant prior art associated with this invention.

### SUMMARY

Drivers of beverage delivery trucks currently have to stand precariously on the side of the truck bay to unload product. This task currently involves continuously having to climb back on and off to take cases off the truck and set the cases on handtrucks. This invention makes it possible for the driver to unload cases onto a sliding ramp down which the cases slide and automatically stack on the handtrucks. The sliding ramp attaches to a collapsible stand which also serves as a stand to support the person as he unloads the cases. The objective is to eliminate excessive climbing and awkward handling of product. The advantage of this tool is that it provides a means of enabling the operator to safely reach the product and slide several cases onto handtrucks without having to excessively climb on and off the truck. The device is manufactured of aluminum to make it lightweight and easy to carry and assemble.

### DRAWING FIGURES

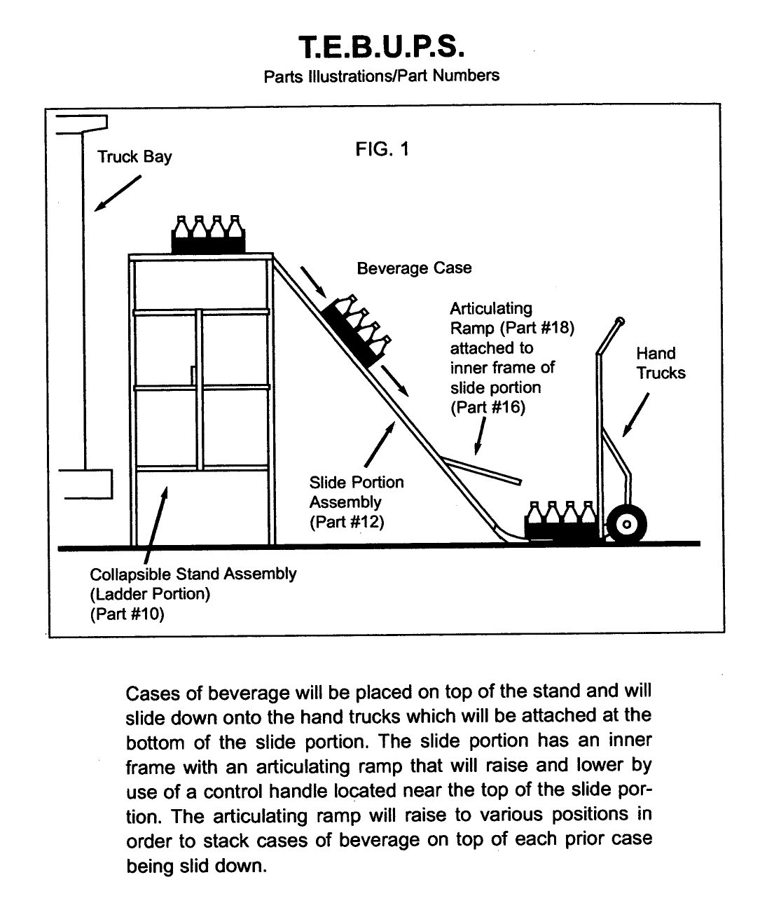

FIG. 1
Shows an overview of operation and intent of tool with part numbers referenced.

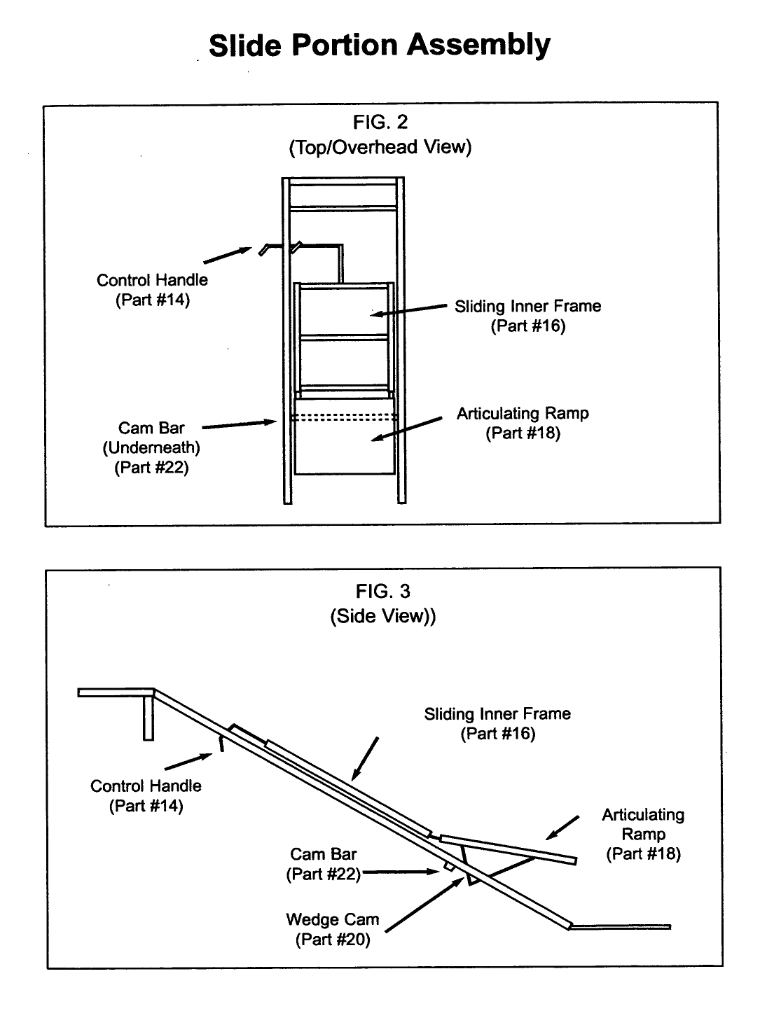

FIG. 2
Slide Portion Assembly—Overhead View with part numbers referenced.

FIG. 3
Slide Portion Assembly—Side View with part numbers referenced.

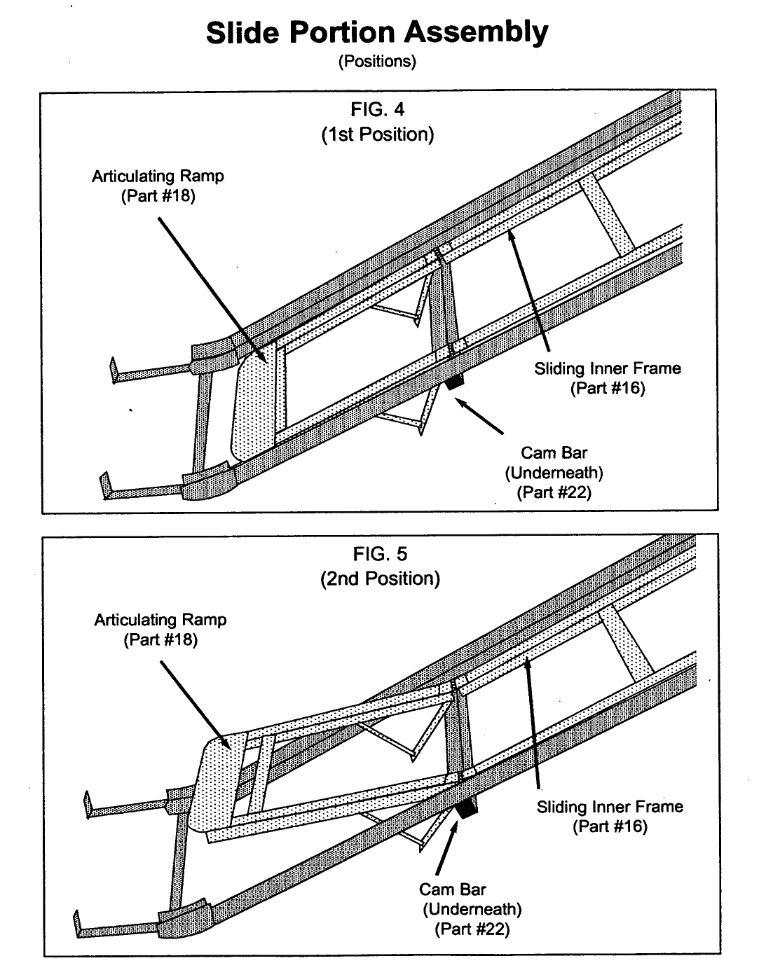

FIGS. 4, 5, & 6
Shows different positions of Articulating Ramp and Slide Portion Assembly

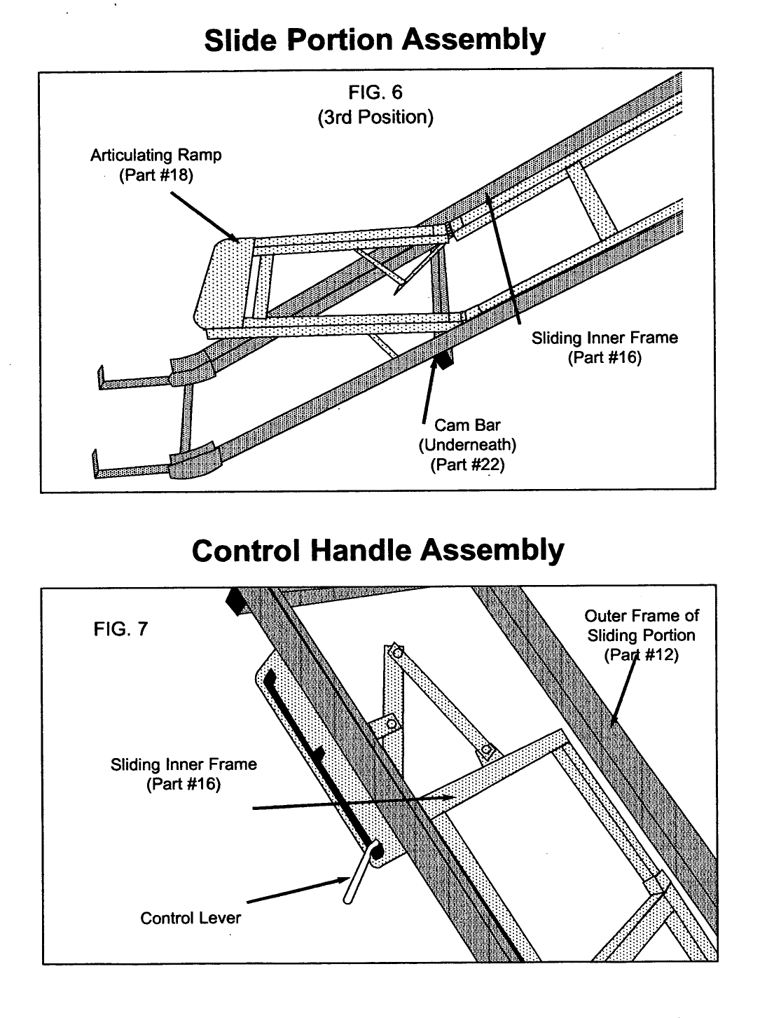

FIG. 7
Control Handle for changing positions of Articulating Ramp

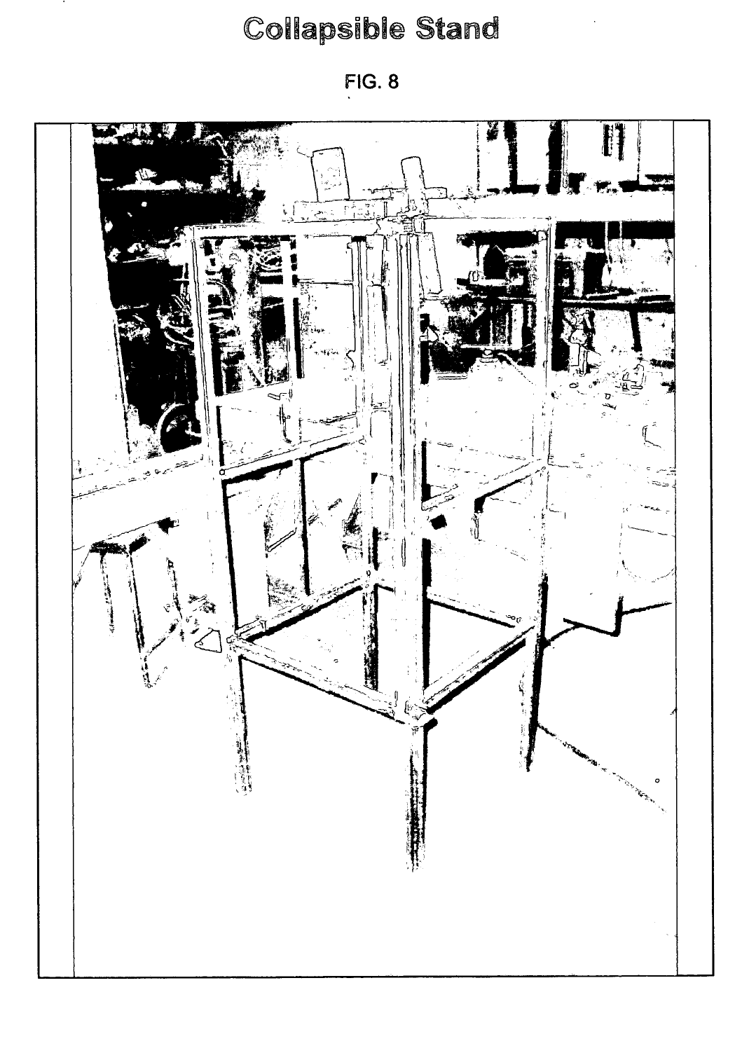

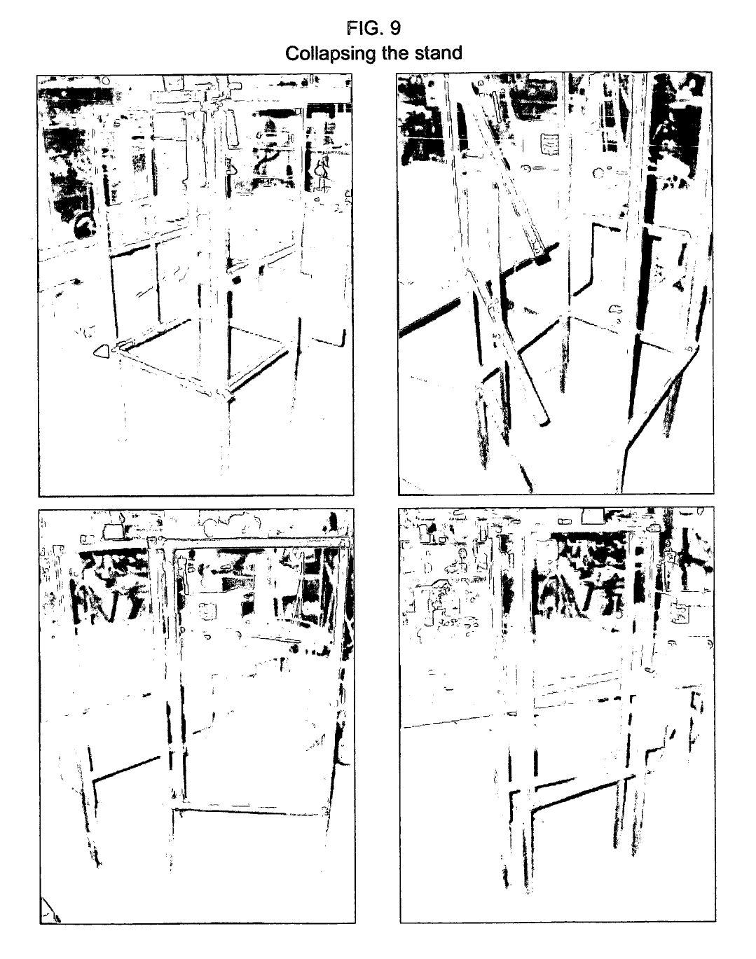

FIG. 8
Collapsible Stand

FIG. 9
Collapsing the Stand

LIST OF REFERENCE NUMERALS

| | |
|---|---|
| Part 10 | Collapsible Stand |
| Part 12 | Slide Portion |
| Part 14 | Control Handle |
| Part 16 | Sliding Inner Frame |
| Part 18 | Artciulating Ramp |
| Part 20 | Wedge Cam |
| Part 22 | Cam Bar |

### DESCRIPTION

The Ergonomic Bay Unloading Product Stacker (TEBUPS) is built of aluminum and consists of two separate structures. One is a collapsible stand that is approximately 60 inches high, 20 inches wide and 24 inches deep. The other structure is a sliding portion that attaches to the collapsible stand. This sliding portion consists of an outer frame and an inner frame with an articulating ramp. The inner frame moves up and down into various positions within the outer frame and is moved into these positions by using a control handle. The overall length of the sliding portion is 84 inches.

### Operation

### Main Embodiment

The Ergonomic Bay Unloading Product Stacker (TEBUPS) is to be used as an aid for unloading bay-type delivery trucks used in the beverage industry. The collapsible stand and sliding portion are carried on the truck and removed and set-up at each delivery location where applicable. The delivery person places the stand next to the bay area of the truck and attaches the sliding portion to this stand. The delivery person then climbs onto the side of the truck, using the stand as a foothold and takes product from the truck bay area and places them onto the sliding portion of the TEBUPS. Each product case slides down the sliding portion ramp to a set of handtrucks that is held in position by backstops attached to the base of the sliding portion. After use, the sliding portion is detached from the stand, the delivery person collapses the stand and both stand and sliding portion are placed back onto the truck.

### DESCRIPTION

### Alternative Embodiments

The Ergonomic Bay Unloading Product Stacker (TEBUPS) can be customized during construction to adapt to different types of bay-trucks used in the beverage industry. These embodiments would generally be a matter of size and dimension modifications, but may also include adapting the assembly to include permanent attachment to the truck wherein the assembly could be pulled and snapped into position for use.

1. The ergonomic bay unloading product stacker (TEBUPS) is the only known device of its type in use by any industry for unloading bay-type trucks.
This device is designed as an ergonomic tool to help eliminate injuries associated with unloading bay trucks including torso and back injuries that currently occur without using this device.
This device is lightweight, practical and easily stored on the truck and easily assembled and disassembled.
